(19) United States
(12) Patent Application Publication
(10) Pub. No.: US 2005/0170966 A1
(43) Pub. Date: Aug. 4, 2005

(54) Surfactants and surfactant compositions

(76) Inventors: Edward George Scovell, CLEVELAND (GB); Trevor Graham Blease, Cleveland (GB)

Correspondence Address: Mayer Brown Rowe & Maw;Intellectual Property Department, 1909 K Street N W, Washington, DC, 20006-1101, US

(21) Appl. No.: 10/504,126

(22) PCT Filed: Feb. 7, 2003
(86) PCT No.: PCT/GB03/00566

(30) Foreign Application Priority Data
Feb. 11, 2002 (GB) 0203105.2

(51) Int. Cl. A01N 57/18; A01N 43/40; A01N 25/16

(52) U.S. Cl. 504/206; 504/365; 424/405; 562/557; 504/250

(57) ABSTRACT

Surfactant compounds are of the general formula (I):
R¹(R²)X¹CH₂CH(OH)CH₂(OA)ₙOR³ (I)
where R¹ is hydrocarbyl; R² is hydrocarbyl; R² is H or hydrocarbyl; X¹ is a nitrogen containing group as defined, and R³ is hydrocarbyl, and X¹ n and AO have defined meanings, provided that at least one group R¹, R² or R³ is or contains a C₆ to C₃₀ hydrocarbyl group. The compounds of the formula (I) can function as surfactants in agrochemical formulations, particularly as emulsifiers, wetting agents, dispersants, thickeners or solubilisers and, especially as adjuvants; or as and, especially for amino oxide or quaternary compounds, in personal care formulations or as fabric softeners. The compounds can be used as adjuvants particularly where the agrochemical is a plant growth regulator, herbicide, and/or pesticide, for example insecticides, fungicides, acaricides, nematocides, miticides, rodenticides, bactericides, molluscicides and/or a bird repellent. Particularly useful formulations include water soluble herbicide(s), particularly such as Glyphosate, Sulfosate, Glufosinate and Paraquat.

This invention relates to surfactant compounds and to agrochemical compositions including them in which the surfactant compounds include amino and polyoxyalkylene functionality, a hydrophobic residue and a glycidyl linking group.

The present invention accordingly provides compounds of the formula (I):
R¹—(R²)X¹—CH₂—CH(OH)—CH₂—(OA)ₙ-OR³ (I)
where
R¹ is hydrocarbyl, particularly C₁ to C₃₀ hydrocarbyl, especially alkyl, hydroxyalkyl or alkoxyalkyl;
R² is H or hydrocarbyl, particularly C₁ to C₃₀ hydrocarbyl, especially alkyl, hydroxyalkyl or alkoxyalkyl, or a group of the formula: —X¹(R¹)—CH₂—CH(OH)—CH₂—(OA)ₙ-OR³
   where X¹, R¹, OA, n and R³ are as defined;
X¹ is N; N⁺->O⁻; N⁺R⁴⁻ where: R⁴⁻ is C₁ to C₆ hydrocarbyl carrying an anionic substituent, particularly —CH₂—COO⁻; or N⁺R⁵ An⁻ where: R⁵ is a C₁ to C₂₀ hydrocarbyl, particularly alkyl, hydroxyalkyl, alkoxyalkyl or aralkyl; and An⁻ is a charge balancing anion e.g. alkali metal or ammonium;
OA is an oxyalkylene residue;
n is from 1 to 100; and
R³ is hydrocarbyl, particularly C₁ to C₃₀ hydrocarbyl, usually C₆ to C₃₀, more particularly C₁₀ to C₃₀, especially alkyl, alkenyl, alkaryl, aryl or aralkyl;
provided that at least one group R¹, R², R³ or R⁵ (when present) is or contains a C₆ to C₃₀ hydrocarbyl group.

The invention specifically includes compounds of the formulae (IIa) or (IIb) [within the general formula (I)]:
R¹—(R²)N—CH₂—CH(OH)—CH₂—(OA)ₙ-OR³ (IIa)
where R¹, R², R³ and n are as defined above for formula (I).
   R¹—(R²)X^{1a}—CH₂—CH(OH)CH₂—(OA)ₙ-OR³ (IIb)
where R¹, R², R³ and n are as defined above for formula (I); and X^{1a} is N⁺->O⁻, N⁺R⁴⁻ or R⁵An³¹ where: R⁴⁻, R⁵ and An⁻ are as defined above for formula (I).

The group(s) R¹ and R³ are and R² and R⁵ may be hydrocarbyl groups. These hydrocarbyl groups are particularly C₁ to C₃₀ hydrocarbyl, more particularly alkyl, hydroxyalkyl or alkoxyalkyl groups. The hydrocarbyl groups can be straight chain group or may be branched or a mixture of straight chain and branched groups. At least one such hydrocarbyl group is or contains a C₆ to C₃₀ hydrocarbyl group. Such longer chain hydrocarbyl group(s) are included to provide at least one hydrophobe moiety in the molecule. Usually the hydrophobic moiety will be a C₈ to C₃₀, more usually a C₁₀ to C₃₀, particularly a C₁₂ to C₂₂, especially a C₁₂ to C₁₈, group. The hydrophobic moiety may also be aralkyl, particularly C₇ to C₁₂ aralkyl group, such as a benzyl, or alkyl phenyl e.g. C₈ to C₁₈ alkyl phenyl and particularly 3-linear alkyl phenyl. Such groups can be derived from cardanols (3-alkyl phenols) which are readily biodegradable compounds (and can be derived from cashew nut shells).

One or more of the hydrocarbyl groups in R¹, R² and R³ need not be a relatively long chain group but may be a group with fewer than 6 carbon atoms in it. Such relatively small groups can act as blocking groups during synthesis, and for this are typically lower e.g. C₁ to C₆, alkyl groups, particularly methyl or ethyl groups. Such relatively small hydrocarbyl groups can also be substituted alkyl e.g. mono-hydroxy or alkoxy substituted alkyl, particularly C₂ to C₆ alkyl which is mono-hydroxy substituted e.g. hydroxyethyl, particularly 2-hydroxyethyl, or hydroxypropyl, particularly 3-hydroxypropyl, or C₁ to C₆ alkyl substituted with alkoxy, particularly C₁ to C₆ alkoxy and especially methoxy, ethoxy or propoxy, so that the alkoxyalkyl is particularly 2-methoxyethyl, 2-ethoxyethyl, 3-methoxypropyl, or 3-ethoxypropyl. The additional hydroxyl group or oxygen atom may provide a modest increase in hydrophilicity or water solubility.

The hydrocarbyl groups in R¹, R² and R³ can be the same or different, depending on the properties desired for the compound.

The group —CH₂—CH(OH)—CH₂— functions to link the substituted amino group with the hydrophilic group (OA)ₙ. As such its precursor(s) provide suitable reactivity to enable the “linking” reactions but desirably do not include functionality that would interfere with the desired properties of the end products. This group includes a hydroxyl group, typically derived from epoxy or glycidyl functionality in synthetic precursors, which may provide a modest increase in the hydrophilicity of the end product.

The polyoxyalkylene chain —(OA)ₙ- will usually provide the main hydrophilic group in the molecule and desirably the group OA is a C₂ or C₃ group, usually oxyethylene (—C₂H₄O—) and/or oxypropylene (—C₃H₆O—). Desirably, in order to maximise the contribution to hydrophilicity, all the groups OA will be oxyethylene. However, if desired, e.g. to make the product more fluid, a mixture of oxyethylene and oxypropylene can be used, in which case the molar ratio of oxyethylene to oxypropylene is desirably from 1:1 to 10:1, more usually at least 4:1. When both oxyethylene and oxypropylene groups are present, the polyoxyalkylene chain can be a random or block copolymeric chain. The length of this chain can be varied to adjust the solubility or HLB (hydrophile/lipophile balance) of the surfactant and generally, short polyoxyalkylene chains e.g. up to 5 OA units, will give relatively hydrophobic surfactants and relatively long chains e.g. over 15 OA units, particuarly oxyethylene units, will give relatively hydrophilic surfactants. Further, as is known for non-ionic surfactants a high proportion of oxyethylene units will tend to give a relatively hydrophilic product and a high proportion of other e.g. oxypropylene units, will give a relatively hydrophobic product. Generally, within the range 1 to 100, n is desirably 8 to 50, particularly 10 to 30, and the proportion of oxyethylene units will usually be at least 50, more usually at least 80, and potentially up to 100, mole %. The number of units in the (poly)oxyalkylene chain, ‘n’, is an average value and may be non-integral.

The group X¹ is a nitrogen atom which either has no further substituent (other than R¹, R² and the glycidyl linking group) or includes a substituent which makes the group a quaternary group, so that when X¹ is a substituted nitrogen atom it can be an amine oxide group N-->O; a group N⁺R⁴⁻; or N⁺R⁵ An⁻.

When X¹ is a group N⁺R⁴⁻, the group R⁴ is a C₁ to C₆ hydrocarbyl group carrying an anionic substituent (nominally carrying a balancing negative charge). Thus, typically R⁴— is a carboxyalkyl group, particularly a —CH₂—COO⁻ group, forming a betaine structure, although other possibilities include, alkyl sulphate, alkyl sulphonate, alkyl phosphate and alkyl phosphonate groups. The precise charge status and the presence of other ions associated with such groups will depend mainly on the pH. At near neutrality, the compound is likely to exist mainly as the zwitterion, whereas remote from neutrality, the quaternary nitrogen or the anionic group in R⁴ may become associated with charge balancing ions. The charge balancing ions will usually be alkali metal or onium (ammonium or amine onium) ion for the anionic, usually carboxyl, group and halide, sulphate, phosphate or carboxylic acids for the amine function.

When X¹ is a group N⁺R⁵ An⁻, the group R⁵ is a C₁ to C₂₂ hydrocarbyl, particularly an alkyl group and more usually a C₁ to C₆ or a C₁₀ to C₁₈ alkyl group, a C₂ to C₆ hydroxy alkyl group, a (C₁ to C₆)alkoxy (C₁ to C₆)alkyl group or a C₇ to C₁₂ aralkyl, particularly a benzyl, group. Where R⁵ is an alkyl group, it will most commonly be a C₁ to C₆ alkyl, particularly methyl, group, although it may be a longer chain e.g. C₆ to C₃₀, particularly a C₈ to C₂₂ alkyl, group and such a longer chain group will tend to act as a secondary hydrophobe. The anion group An⁻ is a charge balancing anion and can be any suitable counterion, for example mineral acid anions such as a halide, particularly chloride or bromide, sulphate or phosphate ion or a fatty carboxylate species.

The compounds of and used in the invention can be made by routes involving generally conventional synthetic steps.
Compounds of the formulae (IIa) can be made by reacting an amine: R¹, R²NH with a glycidyl ether of the formula: 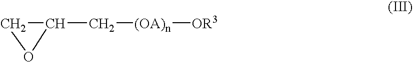
under nucleophilic epoxide ring opening conditions. To make mono-glycidyl compound a molar ratio fo about 1:1 will generally be used and for bis-glycidyl compounds a molar ratio of about 1:2 will generally be used.
Amine oxide compounds of the formulae (IIb) can be made by oxidising e.g. with hydrogen peroxide, an amine of the formula: R¹—(R²)N—CH₂—CH(OH)—CH₂—(OA)ₙ-OR³.
Betaine or analogous compounds of the formulae (IIb) can be made by reaction of an amine of the formula: R¹—(R²)N—CH₂—CH(OH)—CH₂—(OA)ₙ-OR³ with a reactive precursor of the group R⁴⁻, typically a halogen derivative, under nucleophilic substitution conditions.
Quaternary ammonium compounds of the formula (IIb) can be made by reaction of an amine of the formula: R¹—(R²)N—CH₂—CH(OH)—CH₂—(OA)ₙ-OR³ with a quaternizing, usually an alkylating, agent.

In these outline reaction sequences the groups R¹, R², R³, R⁴, Link, OA and n are as defined above.

Typically, reactions of epoxides and amines in the syntheses outlined above are carried out by heating the reagents in solution or dispersion in an inert solvent or diluent (glycols such as monopropylene glycol are suitably inert for this purpose).

Glycidyl ethers of the formula (II) used as intermediates in the above sequences can be made by reacting an alcohol of the formula R³—(OA)ₚ-OH with epi-chlorohydrin under nucleophilic substitution conditions (of course avoiding conditions that promote epoxide ring opening).

The compounds of the invention can be used in a variety of end use applications, including in agrochemical formulations particularly as emulsifiers, wetting agents, dispersants, thickeners, solubilisers, or and especially as adjuvants, and the invention accordingly includes agrochemical formulations incorporating compounds of the formula (I), particularly formulae (IIa) and (IIb), particularly as as adjuvants, but also possibly as emulsifiers, wetting agents, dispersants, thickeners or solubilisers; and, especially for amino oxide or quaternary compounds, in personal care formulations or as fabric softeners.

The use in agrochemical formulations is particularly important and the invention accordingly includes agrochemical compositions which include an agrochemically active compound and, particularly as an adjuvant, at least one compound of at least one of the formulae (I), particularly of one of the formulae (IIa) or (IIb). The invention further includes the use of compounds of any of the formulae (I), particularly (IIa) or (IIb), as agrochemical surfactants, particularly as adjuvants. The invention additionally includes such agrochemical compositions and uses employing compounds of the formula (I′) (in effect a variant of the formula (I) but including the possibility that n=0):
R¹—(R²)X¹—CH₂—CH(OH)—CH₂—(OA)_{n′}-OR³ (I′)
where R¹, R², X¹, OA, and R³ are as defined above for formula (I) and n′ is from 0 to 100. Correspondingly this aspect of the invention also includes agrochemical compositions including and the use of compounds of the formulae (IIa′) or (IIb′):
R¹—(R²)N—CH₂—CH(OH)—CH₂—(OA)_{n′}—-OR³ (IIa′)
R¹—(R²)X^{1a}—CH₂—CH₂(OH)CH₂—(OA)ₙ-OR³ (IIb′)
where R¹, R², R³, X^{1a} and OA are as defined above for the formulae (IIa) and (IIb) respectively and n′ is as defined above for formula (I′).

Compounds of the formula (I′), particularly (IIa′) and (IIb′) can be made by methods analogous to those used ot make compounds of the formuls (I).

Surfactants of the formula (I) and particularly of the formulae (IIa) or (IIb) can be used (particularly as adjuvants) with a wide range of agrochemical active materials and specifically, the active component of the formulation may be one or more plant growth regulators, herbicides, and/or pesticides, for example insecticides, fungicides, acaricides, nematocides, miticides, rodenticides, bactericides, molluscicides and bird repellants. Specific examples of actives include:

Herbicides: including
water soluble, particularly non-selective, herbicides, more particularly phosphonomethyl glycines, especially as salts such as Glyphosate and Sulfosate {respectively the iso-propylamino and trimethylsulphonium salts of N-phosphonomethyl glycine}; and phosphinyl amino acids such as Glufosinate {2-amino-4-(hydroxymethylphosphinyl)butanoic acid} particularly as the ammonium salt and bipyridinium compounds such as Paraquat {1,1′-dimethyl-4,4′-bipyridinium};
triazines such as Atrazine {6-chloro-N-ethyl-N-(1-methylethyl)-1,3,5-triazine-2,4-diamine, and Prometryn {N,N′-bis(1-methylethyl)-6-(methylthio)-1,3,5-triazine)-2,4-diamine};
substituted ureas such as Diuron (N′-(3,4-dichlorophenyl)-N,N-dimethylurea);
sulphonyl ureas such as metsulfuron-methyl {2-[[[[(4-methoxy-6-methyl-1,3,5-triazin-2-yl) amino]carbonyl]amino]sulfonyl]benzoate}, triasulfuron {2-(2-chloroethoxy)-N-[[(4-methoxy-6-methyl-1,3,5-triazin-2-yl)amino]carbonyl]benzenesulfonamide}, tribenuron-methyl {methyl 2-[[[[(4-methoxy-6-methyl-1,3,5-triazin-2-yl)-methylamino]carbonyl]amino]sulfonyl]benzoate} and chlorsulfuron {2-chloro-N-[[(4-methoxy-6-methyl-1,3,5-triazin-2-yl) amino]carbonyl]benzenesulfonamide};
pyridine carboxylic acids such as clopyralid {3,6-dichloropyridine-2-carboxylic acid};
aryloxy alkanoic acids such as 2,4-D{2,4-dichlorophenoxyacetic acid};
2-(4-aryloxyphenoxy)propionic acids such as clodinafoppropargyl {prop-2-ynil (R)-2-[4-(5-chloro-3-fluoropyridinr-2-yloxy)phenoxy]-propionate); and
bis-carbamates such as Phenmedipham (3-[(methoxycarbonyl)amino]phenyl(3-methyl phenyl)carbamate}.

Fungicides: including
thiocarbamates, particularly alkylenebis(dithiocarbamate)s, such as Maneb {[1,2-ethanediylbis-[carbamodithiato](2-)]manganese} and Mancozeb {[[1,2-ethanediyl-bis[carbamodithiato]](2-)]manganese mixture with [[1,2-ethanediylbis[carbamodithiato]](2-)]zinc};
strobilurins such as azoxystrobin {methyl (E)-2-[[6-(2-cyanophenoxy)-4-pyrimidinyl]oxy]-a-(methoxymethylene)benzeneacetate} and kresoxim-methyl {(E)-a-(methoxyimino)-2-[(2-methylphenoxy)methyl]benzeneacetic acid methyl ester};
dicarboximides such as Iprodione {3-(3,5-dichlorophenyl)-N-isopropyl-2,4-dioxo imidazolidine 1-carboxamide};
halogenated phthalonitriles such as 2,4,5,6-tetrachloro-1,3-dicyanobenzene;
benzimidazoles such as Carbendazym {methyl benzimidazol-2-yl carbamate};
azoles such as Propiconazole {1-[2-(2,4-dichlorophenyl)-4-propyl-1,3-dioxolan-2-yl-methyl-1H-1,2,4-triazole}, and Tebuconazole {(RS)-1-p-chlorophenyl-4,4-dimethyl-3-(1H-1,2,4-triazole-1-ylmethyl)-pentan-3-ol}; and
inorganic fungicides such as Copper hydroxide {Cu(OH)₂};
benzoyl ureas such as Diflubenzuron {N-[[(4-chlorophenyl)amino]carbonyl]-2,6-difluoro-benzamide)} and pyrethroid insecticides; and

Acaricides including: tetrazines such as Clofentezine {3,6-bis(2-chlorophenyl)-1,2,4,5-tetrazine}.

The compounds of the invention can be particularly effective as adjuvants for herbicides particularly water soluble, usually non-selective herbicides for example glyphosate types (N-phosphonomethyl glycines and their agrochemically acceptable salts), such as Glyphosate (the iso-propylamine salt of N-phosphonomethyl glycine) and Sulfosate (the trimethylsulphonium salt of N-phosphonomethyl glycine); glufosinate types (phosphinyl amino acids and their agrochemically acceptable salts) such as Glufosinate (2-amino-4-(hydroxymethylphosphinyl) butanoic acid, particularly as the ammonium salt); and bipyridinium types such as Paraquat (1,1′-dimethyl-4,4′-bipyridinium). Such water soluble actives can be used as the sole active in for example in aqueous solutions or in water dispersible granules, but more usually, they will be used in combination with water insoluble or immiscible actives in multi active formulations. In particular, formulations can be made up using a water soluble (non-specific) herbicide such as Glyphosate, Sulfosate and/or Glufosinate, with a selective herbicide, such as a sulphonyl urea e.g. metsulfuron-methyl, pyridine carboxylic acid e.g. clopyralid, aryloxy alkanoic acids e.g. 2,4-D, substituted ureas e.g. diuron, or 2-(4-aryloxyphenoxy)propionic acids e.g. clodinafoppropargyl, and/or with an insecticide and/or fungicide.

Generally, when used as adjuvants in agrochemical formulations, the compounds of and used in this invention can be added to agrochemical formulations as part of the tank mix (the formulation actually used for spraying) or can be included in pre-formulated products which usually take the form of concentrates, emulsifiable concentrates or solid dispersible granules.

When added to tank mix compositions for spray formulations using current spray application rates, generally from 100 to 400 l(spray).ha⁻¹ (crop treated), usually about 300 l.ha⁻¹, the concentration of the active agrochemical is typically from about 0.05 to about 3%, more usually from 0.1 to about 0.5 and particularly about 0.2% by weight of the spray formulation and the concentration of adjuvant will typically be 0.02 to about 2%, more usually 0.2 to about 1% and particularly about 0.1%. The weight ratio of active agrochemical to adjuvant is usually from 1:5 to 10:1, more usually from 1:2 to about 4:1. These figures correspond to crop application rates of the active agrochemical generally in the range 300 to 4000 g.ha⁻¹, more usually from 750 to about 2000 g.ha⁻¹ (the actual amount depending on the particular crop, agrochemical and effect desired). For low volume spraying, generally higher spray concentrations will be used, but the ratio of agrochemical to adjuvant will be within the ranges given above.

The surfactants of the formula (I) can be used as “built in” adjuvants in concentrate agrochemical formulations that are intended for dilution prior to use. In such concentrates, the concentration of active agrochemical is typically from about 5 to about 60%, more usually from 10 to 40% and the adjuvant concentration is from about 3 to about 50%, more usually from 5 to 30% by weight of the concentrate. The use as built in adjuvants in concentrates is particularly applicable for concentrates where the carrier is aqueous and the active is or includes one or more water soluble herbicides, such as Glyphosate, Sulfosate and Glufosinate.

As adjuvants the compounds of and used in this invention can provide faster effectiveness of agrochemicals especially water soluble herbicides, particularly of the glyphosate type, and can have significantly lower toxicity, particularly aquatic toxicity, than conventional adjuvants, particularly those based on fatty amine ethoxylates. The improved toxicity is also important when the compounds are used to provide other surfactant effects in agrochemical formulations.

Agrochemical formulations of the invention can be made up using surfactants of the formula (I) as adjuvants in a variety of formulation types including:

i Water soluble liquids (aqueous dilutable solutions) in which water soluble agrochemical active(s) and surfactant(s) are dissolved in water and the formulation is diluted with water before use. Typically such formulations use concentrations within the ranges:

| | |
|---|---|
| agrochemical active: | 100 to 500 g · l⁻¹ |
| surfactant: | 30 to 500 g · l⁻¹ |

The surfactant can be a mixture of compounds of the formula (I) and other, particularly non-ionic surfactants (see also below about mixtures).
Possible other components in such formulations include
i antifoams, particularly polysiloxane antifoams, typically included at a concentration of from 0.1 and 10% by weight of the concentrate formulation; and
ii viscosity modifiers: gums, e.g. xanthan gums, modified cellulose e.g. carboxymethyl, -ethyl or -propyl cellulose, typically included at between 0.01 and 5% by weight of the concentrate formulation.
Such concentrate formulations can be made by simple mixing of the components. Conveniently this may be carried out by dissolving the agrochemical active(s) and the adjuvant surfactant(s) and any other components in water to give either a concentrate for subsequent dilution to end use concentrations or directly at end use concentration e.g. in the spray tank.

ii Liquid concentrates, particularly emulsifiable concentrates, can include compounds of the formula (I). The amount of surfactant(s) used in such concentrates is typically from 1 to 30% by weight of the concentrate. Other surfactants such as non-ionic, amphoteric, cationic or anionic or combinations of such surfactants may be used together with compounds of the formula (I) (see also below about mixtures). In liquid concentrates, typically use concentrations are within the ranges:

| | |
|---|---|
| agrochemical | 0.2 to 10% by weight (though with liquid agrochemicals, |
| active: | the concentration can be up to 90%); and |
| surfactant: | 1 to 20% by weight of the liquid concentrate. |

Liquid concentrate agrochemical formulations may also include:
solvents such as monoethylene glycol, diethylene glycol, glycerol, (mono)propylene glycol, which, especially with propylene glycol, may also act as a humectant, typically in an amount from 5 to 500% by weight of the surfactants;
oils, particularly vegetable or mineral oils, such as spray oils, typically in an amount from 5 to 500% by weight of the surfactants;
salts, such as ammonium chloride and/or sodium benzoate, and/or urea as gel inhibition aids typically in an amount from 1 to 10% by weight of the formulation.
iii Solid dispersible granules—the surfactant can be included in a granular agrochemical active formulation or itself be formulated as dispersible granules. Typically granules including agrochemical active contain from 1 to 80%, more usually from 1 to 30%, by weight of the granule of active. When included in granules containing an agrochemical active, the adjuvant typically forms from 5 to 50% by weight of the granule. The granules can include clathrates, particularly urea clathrates, in particular incorporating the compound of the formula (I). Such clathrates can be made by forming a co-melt, including the urea and surfactant, and cooling by e.g. spray cooling. Such clathrate solid granules will typically have a ratio of urea to surfactant adjuvant of from 1:2 to 5:1 by weight. Clathrates can be included in the agrochemical granules or and desirably formulated as a separate adjuvant granule which can be used by direct mixing with granular agrochemical active compositions.
   When the adjuvant is provided in separate granules from the active agrochemical, the mixing rate of adjuvant granules to agrochemical active granules will depend on the respective concentrations in the granules, but will usually be such as to give a ratio of adjuvant to agrochemical active within the ranges described above.
   In such granular formulations, other possible components of the granules include:
   binders, particularly binders which are readily water soluble to give low viscosity solutions at high binder concentrations, such as polyvinylpyrrolidone, polyvinylalcohol, carboxymethyl cellulose, gum arabic, sugars, starch, sucrose and alginates;
   diluents, absorbents or carriers such as carbon black, talc, diatomaceous earth, kaolin, aluminium, calcium and/or magnesium stearate, sodium tripolyphosphate, sodium tetraborate, sodium sulphate, sodium, aluminium or mixed sodium-aluminium silicates; and sodium benzoate;
   disintegration agents, such as surfactants, materials that swell in water, for example carboxymethyl cellulose, collodion, polyvinyl pyrrolidone and/or microcrystalline cellulose swelling agents; salts such as sodium and/or potassium acetate, sodium carbonate, bicarbonate and/or sesquicarbonate, ammonium sulphate and/or dipotassium hydrogen phosphate;
   wetting agents such as alcohol alkoxylates, particularly ethoxylates or ethoxylate/propoxylates;
   dispersants such as sulphonated naphthalene formaldehyde condensates and acrylic copolymers; and
   antifoam agents, typically at a concentration of from 1 to 10% by weight of the granule.

Spray formulations at application concentration, including surfactants of the formula (I), particularly as adjuvants, can be made up by diluting/dispersing the agrochemical active and the adjuvant in the spray liquid (usually water). Also concentrate forms of the agrochemical formulation can be used, for example:
i liquid concentrate containing the agrochemical active and, particularly adjuvant, surfactant dissolved in water;
ii liquid concentrate containing the agrochemical active dissolved or dispersed in a non-aqueous, water immiscible liquid, which may be an emulsifiable concentrate and may include a proportion of water, including an adjuvant surfactant;
iii liquid concentrate containing the agrochemical active dissolved or dispersed in a non-aqueous, water miscible liquid and including an adjuvant surfactant;
iv a solid granular concentrate of or containing the agrochemical active and optionally including an adjuvant surfactant, or the adjuvant surfactant can be provided separately for example as a solution in a solvent (water or a non-aqueous solvent) or a granule, particularly a urea adduct, containing the adjuvant.

Concentrated forms of the agrochemical active will typically be diluted from 10 to 10000, particularly 30 to 1000 times to generate the agrochemical spray for use.

Agrochemical formulations often include more than one surfactant either because surfactants are used in combination to achieve the desired effect or used to provide different effects. It is thus possible in this invention to use combinations of more than one surfactant of the formula (I) or to combine surfactant(s) of the formula (I) with other surfactants.

For adjuvancy, mixtures of adjuvant surfactants can be used and the invention includes agrochemical formulations including compounds of the formula (I) in combination with other adjuvant materials. Commonly such other adjuvants may be non-ionic surfactant adjuvants and examples include so-called hydrocarbyl, particularly alkyl, polysaccharides (generally more correctly described as oligosaccharides); hydrocarbyl, particularly alkyl, amine alkoxylates, particularly ethoxylates, linear or mono-branched alcohol alkoxylates, particularly ethoxylates; sorbitol fatty acid esters; sorbitan fatty acid esters; and ethoxylated sorbitan fatty acid esters. The proportion of compounds of the formula (I) and other adjuvants, particularly non-ionic surfactant adjuvant, (when used) is typically from 1:5 to 10:1, more usually from 1:1 to 5:1 by weight. The proportions and concentrations of adjuvants referred to above include both compound(s) of the formula (I) and other, particularly non-ionic surfactant adjuvants. Co-adjuvants, including ionic and/or inorganic materials, for example ammonium sulphate, may be included in adjuvant containing agrochemical formulations of the invention, particularly with non-ionic surfactant adjuvants, especially including those of the formula (I), optionally used in combination with other, particularly non-ionic, surfactant adjuvants.

Generally when other surfactants, especially non-ionic surfactants are used, the compound(s) of the formula (I) will be at least 25% and more usually at least 50% of the total surfactant used to provide the desired effect.

Other conventional components can be included in such formulations such as one or more oils e.g. mineral oil(s), vegetable oil(s) and alkylated vegetable oil(s) which are, typically C₁ to C₈, alkyl mono esters of vegetable oil fatty acids; solvents and/or diluents such as ethylene and/or propylene glycol or low molecular weight alcohols, which act to solubilise the formulation and/or to reduce the viscosity and/or to avoid or reduce dilution problems e.g. the formation of gels. In particular where non-aqueous, particularly those which are not miscible with or soluble in water, liquids are included e.g. as solvents for the agrochemical and/or in a concentrate to form an emulsion on dilution with water for spraying, other surfactants may be included as solubilisers and/or emulsifiers. Such materials will typically be chosen from anionic, cationic and/or non-ionic surfactants for their effectiveness in solubilisation and or emulsification. Such other surfactant components will, as with formulations using purely conventional surfactants, be used in amounts based on the desired effect.

Other surfactants may also be included to improve wetting. Examples of such wetting agents include nonionic surfactants such as alcohol ethoxylates for example of C₉ to C₁₅, particularly primary, alcohols, which may be linear or branched, particularly mono-branched, with from 5 to 30 moles of ethylene oxide; and alkoxylates of such alcohols particularly mixed ethoxylate/propoxylates which may be block or random mixed alkoxylates, typically containing from 3 to 10 ethylene oxide residues and from 1 to 5 propylene oxide residues, particularly where the polyalkoxylate chain is terminated with propylene oxide unit(s); polyoxyethylene/polyoxypropylene copolymers, particularly block copolymers, such as the Synperonic PE series of copolymers available from Uniqema, and alkyl polysaccharides; anionic surfactants e.g. isethionates, such as sodium cocoyl isethionate, naphthalene sulphonic acids or sulphosuccinates. The amounts of wetting surfactants are typically similar to or the same as the levels typically used to provide adjuvant effects (see above).

The compounds of the formula (I) may be used in combination with non-surfactant materials, particularly solvents or solvation aids such as glycols such as monopropylene glycol and/or polyethylene glycol. The proportion of compounds of the formula (I) to such solvents or solvation aids, (when used) is typically from 1:5 to 10:1, more usually from 1:1 to 5:1 by weight.

The invention includes a method of treating vegetation by applying to plants and/or soil a composition including a surfactant of the formula (I) and an agrochemical according to the invention. The agrochemical may be one or more of the types of actives described above, particularly, one or more growth regulators, herbicides, and/or pesticides, for example insecticides, fungicides or acaricides. This method of the invention includes:
(i) a method of killing or inhibiting vegetation by applying a formulation which includes one or more growth regulators and/or herbicides and at least one compound of the general formula (I) as an adjuvant, and/or
(ii) a method of killing or inhibiting plant pests by applying a formulation which includes one or more pesticides, for example insecticides, fungicides or acaricides, and at least one compound of the general formula (I) as an adjuvant.

Other additives can be included in agrochemical formulations of the invention including:
inorganic salts such as ammonium chloride, calcium chloride and/or sodium benzoate and/or urea in an amount of from 0.01 to 1% by weight of composition.
antifoams which can be silicon based materials such as organopolysiloxanes, typically used at from 0.1 to 10%, preferably 0.2 to 6% by weight of the surfactant; 0.01 to 5%, particularly 0.02 to 2% by weight of agrochemical concentrate and 0.0001 to 0.1% preferably 0.001 to 0.05% by weight of a spray formulation at end use dilution;
viscosity modifiers, particularly gums such as xanthan gums; cellulose derivatives, such as carboxyl-methyl, -ethyl, or -propyl cellulose, typically used at from 0.01 to 5 wt % of a concentrated formulation; and
other non surfactant materials such as stabilisers and/or anti-microbials, typically used at from 0.01 to 5 wt % of a concentrated formulation.

The following Examples illustrate the invention. All parts and percentages are by weight unless otherwise stated.

Materials

| | |
|---|---|
| Alc1 MBA 13 | a mixture of C13 to C15 linear and branched alcohols |
| Alc1/15EO | 15-ethoxylate of Alc1 |
| FAE1 | tallow amine (20) ethoxylate ex Uniqema |
| | (Atlas G-3780A) |
| Glyphosate | glyphosate iso-propylamine salt as aqueous solution |
| | at 780 g · l⁻¹ active salt NB sprayed amounts of |
| | glyphosate are given as amounts of acid equivalent (a.e.) |

Synthesis Examples SE1 to SE4 Illustrate the Synthesis of the Compounds of the Formula (I).

### SYNTHESIS EXAMPLE SE1

### 1-[Diethylamino]-2-hydroxypropane-3-(Alc1 15-ethoxylate)

(CH₃CH₂)₂N—CH₂CH(OH)CH₂—(OCH₂CH₂)₁₅-Alc1

The glycidyl ether of Alc1/15EO (200 g, 85% w/w active; 0.173 Mol) was charged to a 500 ml five-necked flanged round-bottomed flask, equipped with condenser, stirrer and thermocouple. Diethylamine (17.875 ml; 0.173 Mol) was added using a syringe and allowed to reacted at 40° C. for 3 hours. At the end of the reaction any unreacted diethylamine was removed by applying vacuum for 30 minutes. The product, which had an active tertiary amine content of 86%, was used without further purification. The identity of the product was confirmed by IR and NMR.

### SYNTHESIS EXAMPLE SE2

### 1-[Bis-(2-hydroxyethyl)-amino]-2-hydroxypropane-3-(Alc1 15-ethoxylate)

(HOCH₂CH₂)₂N—CH₂CH(OH)CH₂—(OCH₂CH₂)₁₅-Alc1

The title compound was made by the method of Example SE1, but substituting a corresponding molar amount of diethanolamine for the diethylamine used in SE1.

### SYNTHESIS EXAMPLE SE3

### 1-diethylamino-2-hydroxypropane-3-(stearyl 25-ethoxylate)

(CH₃CH₂)₂N—CH₂CH(OH)CH₂—(OCH₂CH₂)₂₅—C₁₈H₃₇

The title compound was made by the method of Example SE1, but substituting a corresponding molar amount of stearyl alcohol 25-ethoxylate for the Alc1/15 used in SE1.

### SYNTHESIS EXAMPLE SE4

### 1-[Bis-(2-hydroxyethyl)-amino]-2-hydroxypropane-3-(stearyl 25-ethoxylate)

(HOCH₂CH₂)₂N—CH₂CH(OH)CH₂—(OCH₂CH₂)₂₅—C₁₈H₃₇

The title compound was made by the method of Example SE2, but substituting a corresponding molar amount of stearyl alcohol 25-ethoxylate for the Alc1/15EO used in SE1.

The Application Examples illustrate the use of compounds of the invention as adjuvants in agrochemical formulations.

### APPLICATION EXAMPLE AE1

This Example tests the effect of adjuvants on Glyphosate herbicidal activity under field conditions. The herbicide was applied to test plots of weeds at a rate of 1080 g(a.e.).ha⁻¹ (350 l.ha⁻¹ of spray containing 3.086 g.l⁻¹ a.e.) with a weight ratio of active to adjuvant of 2:1=540 g(adjuvant).ha⁻¹. Spray plots were treated with the herbicide formulations, one of each of four adjuvants of the invention (SE1, SE2, SE3, and SE4) a fatty amine ethoxylate (FAE1) for comparison, or left untreated as controls (no weed control). The spray plots were in a completely randomised block design with 3 replicates of 3×5 m plots. the sprayed plots were sprayed using a compressed-air AZO sprayer at a pressure of 2.5 bar, equipped with Teejet XR80015VS nozzles. During this trial, it rained for about 15 minutes about 2 hours after spraying, giving a good indication of the rainfastness off the formulations tested.

The test plots used mixtures of the following weeds at the 2 to 4 leaf stage:

| | |
|---|---|
| Cockspur | Echinochloa crus-galli |
| Fat-hen | Chenopodium album |
| Smartweed | Polygonum persicaria |

The results of spraying were evaluated by visual comparison with untreated control blocks 12, 20 and 35 days after treatment (DAT), assessing chlorosis (chlor) and growth inhibition (inhib) as percentages with 0=no effect and 100=complete kill as compared with the untreated controls. The results are set out in Table 1 below.

TABLE 1

| | | | Effect | | | | | |
|---|---|---|---|---|---|---|---|---|
| | | | 12 DAT | | 20 DAT | | 35 DAT | |
| SCS No | Ex No | Adjuvant | chlor (%) | inhib (%) | chlor (%) | inhib (%) | chlor (%) | inhib (%) |
| — | 1.1C | FAE1 | 52 | 65 | 68 | 68 | 72 | 70 |
| 6499 | 1.2 | SE1 | 62 | 67 | 77 | 78 | 78 | 78 |
| 6498 | 1.1 | SE2 | 68 | 70 | 75 | 75 | 77 | 77 |
| 6506 | 1.3 | SE3 | 62 | 63 | 72 | 72 | 68 | 75 |
| 6507 | 1.4 | SE4 | 63 | 62 | 75 | 75 | 65 | 68 |

### APPLICATION EXAMPLE AE2

In this Example the effect of compounds of the invention as adjuvants for Glyphosate as a herbicide against the species Agropyron repens (couch grass) and Abutilon theophrasti (velvetleaf) using FAE1 as a control adjuvant was tested. Test plots were treated by spraying (spray volume 200 l.ha⁻¹) at varying doses of glyphosate; 180 and 360 g(a.e.).ha⁻¹ for A. repens and 250 and 500 g(active).ha⁻¹ for A. theophrasti and ratios of glyphosate to adjuvant (8:1,4:1 and 2:1 by weight). The effect of the herbicide formulations was assessed by visual comparison with untreated control blocks 6, 13 and 19 days after treatment (DAT), scoring as percentages with 0=no effect and 100=complete kill. The results are set out in Table 2 below

TABLE 2

| Ex | Adj | ratio | Agropyron repens | | | | Abutilon theophrasti | | | |
|---|---|---|---|---|---|---|---|---|---|---|
| No | type | adj:acid | g · ha⁻¹ | 6 DAT | 13 DAT | 19 DAT | g · ha⁻¹ | 6 DAT | 13 DAT | 19 DAT |
| 2.1Ca | FAE1 | 8:1 | 180 | 28.6 | 28.6 | 39.3 | 250 | 17.9 | 25 | 32.1 |
| 2.1Cb | | 4:1 | | 25 | 28.6 | 42.9 | | 14.3 | 28.6 | 32.1 |
| 2.1Cc | | 2:1 | | 28.6 | 53.6 | 67.9 | | 25 | 28.6 | 42.9 |
| 2.1Cd | | 8:1 | 360 | 17.9 | 42.9 | 60.7 | 500 | 25 | 39.3 | 46.4 |
| 2.1Ce | | 4:1 | | 25 | 50.6 | 85.7 | | 28.6 | — | — |
| 2.1Cf | | 2:1 | | 25 | 53.6 | 60.7 | | 28.6 | — | — |
| 2.1a | SE2 | 8:1 | 180 | 25 | 32.1 | 50 | 250 | 21.4 | 28.6 | 42.9 |
| 2.1b | | 4:1 | | 17.9 | 39.3 | 60 | | 17.9 | 28.6 | 35.7 |
| 2.1c | | 2:1 | | 17.9 | 46.4 | 82.1 | | 25 | 32.1 | 42.9 |
| 2.1d | | 8:1 | 360 | 25 | 46.4 | 78.6 | 500 | 25 | 50 | 53.6 |
| 2.1e | | 4:1 | | 25 | 50 | 92.9 | | 28.6 | — | — |
| 2.1f | | 2:1 | | 32.1 | 60.7 | 100 | | 28.6 | — | — |

### APPLICATION EXAMPLE AE3

This Example goves the results of greenhouse trials to investigate the adjuvant properties of compound SE2, with a fatty amine ethoxylate (FAE1) for comparitison, used in combination with glyphosate (isopropylamine salt?) as a herbicide against Couchgrass (Agropyron repens) and Bindweed (Convolvulus arvensis). Glyphosate doses of 180, 360 and 540 g(a.e.).ha⁻¹ were used against A. repens and 540, 810 and 1080 g(a.e.).ha⁻¹ against C. arvensis. The spray volume was 200 l.ha⁻¹ and ratios of glyphosate (active ingredient) to adjuvant of 2:0.75 (37.5%); 2:0.5 (25%); 2:0.25 (12.5%) and 2:0.1 (5%) (percentage figres in brackets are by weight adjuvant based on glyphosate a.e.) were tested. Weed kill was visually assessed 7, 14 and 21 days after treatment (DAT) and the % fresh weight of foliage was determined 22 and 33 DAT for A. repens and C. arvensis respectively. The % kill results at 7 DAT are set out in Table 3a and the % fresh weight of foliage determined 22 and 33 DAT is reported in Table 3b below. The % fresh weight of foliage is determined 22 and 33 DAT for A. repens and C. arvensis respectively and the results are included in Table 3b below:

TABLE 3a

| | | Agropyron repens | | | | | C. arvensis | | | | |
|---|---|---|---|---|---|---|---|---|---|---|---|
| Ex | Adjuvant | Gly | Adj (% Gly) | | | | Gly | Adj (% Gly) | | | |
| No | type | (g/l) | 5 | 12.5 | 25 | 37.5 | (g/l) | 5 | 12.5 | 25 | 37.5 |
| 3.1.C | FAE1 | 180 | 14.29 | 17.86 | 25 | 21.43 | 540 | 14.29 | 14.29 | 14.29 | 17.86 |
| 3.2.C | | 360 | 21.43 | 21.43 | 28.57 | 17.86 | 810 | 14.29 | 14.29 | 14.29 | 14.29 |
| 3.3.C | | 540 | 35.71 | 35.71 | 28.57 | 32.14 | 1080 | 14.29 | 14.29 | 14.29 | 17.86 |
| 3.1 | SE2 | 180 | 17.86 | 17.86 | 21.43 | 21.43 | 540 | 14.29 | 14.29 | 14.29 | 14.29 |
| 3.2 | | 360 | 14.29 | 28.57 | 32.14 | 25 | 810 | 14.29 | 17.86 | 14.29 | 14.29 |
| 3.3 | | 540 | 28.57 | 25 | 35.71 | 39.29 | 1080 | 14.29 | 14.29 | 14.29 | 14.29 |

TABLE 3b

| | | A. repens - % fresh | | | | | C. arvensis - % fresh | | | | |
|---|---|---|---|---|---|---|---|---|---|---|---|
| | | wt 22 days | | | | | wt 33 days | | | | |
| | | Gly | wt % adjuvant | | | | Gly | wt % adjuvant | | | |
| Ex No | Adjuvant | (g/l) | 5 | 12.5 | 25 | 37.5 | (g/l) | 5 | 12.5 | 25 | 37.5 |
| 3.1.C | FAE1 | 180 | 86.9 | 57.51 | 48.69 | 47.69 | 540 | 56 | 50.38 | 51.46 | 53.62 |
| 3.2.C | | 360 | 60.3 | 55.8 | 40.48 | 40.75 | 810 | 59.69 | 52.63 | 53.55 | 39.98 |
| 3.3.C | | 540 | 36.38 | 36.27 | 29.2 | 20.3 | 1080 | 50.51 | 50.15 | 50.8 | 51.1 |
| 3.1 | SE2 | 180 | 95.49 | 59.81 | 48.07 | 53.01 | 540 | 54.61 | 54.21 | 54.97 | 53.73 |
| 3.2 | | 360 | 63.31 | 35.66 | 29.69 | 40.02 | 810 | 53.91 | 62.03 | 52.01 | 55.38 |
| 3.3 | | 540 | 23.83 | 19.63 | 19.6 | 18.36 | 1080 | 50.55 | 53.29 | 46.2 | 43.89 |

### APPLICATION EXAMPLE AE4

In this Example, adjuvants of the invention (SE2), plus TAE1 as control, were tested in field trials in formulations including glyphosate (isopropylamine salt) as a herbicide on flax, pea, Savoy cabbage (Sav C) and Italian ryegrass (It R) as target crops. The application rate was 1080 g(a.e).ha⁻¹, with adjuvant at an application rate of 405 g.ha⁻¹ (75% of the normal application rate for adjuvants in such formulations of 540 g.ha⁻¹). The effectiveness of the formulations was by visual assessment of Growth Reduction (Gr Red) and Chlorosis/Necrosis (Chlor) 6 DAT with the values being reported in % (related to an untreated control=0% effect).

TABLE 4

| | | Flax | | Pea | | Sav C | It R |
|---|---|---|---|---|---|---|---|
| Ex | Adjuvant | Gr Red | Chlor | Gr Red | Chlor | Chlor | Chlor |
| No | type | (%) | (%) | (%) | (%) | (%) | (%) |
| 4.1.C | FAE1 | 20 | 30 | 40 | 80 | 40 | 40 |
| 4.1 | SE2 | 30 | 50 | 55 | 80 | 40 | 50 |

### APPLICATION EXAMPLE AE5

Further field trial runs were carried out similar to Example AE4 on pea and Savoy cabbage as target crops at a lower application rate of glyphosate (570 g(a.e.).ha⁻¹) and using varying application rates for the adjuvant (135, 270 and 405 g.ha⁻¹) with the formulation components being mixed in the spray tank. The % necrosis on the treated crops was assessed as described in Example AE4 14 DAT and the results are given in Table 5 below.

TABLE 5

Adjuvant

| | | amount | | |
|---|---|---|---|---|
| Ex No | type | (g/ha) | Sav C | Pea |
| 5.1.C | FAE1 | 135 | 10 | 70 |
| 5.2.C | | 270 | 10 | 70 |
| 5.3.C | | 405 | 10 | 70 |
| 4.1 | SE2 | 135 | 40 | 70 |
| 4.2 | | 270 | 40 | 90 |
| 4.3 | | 405 | 60 | 95 |

1. A compound of the formula (I):
R¹R²X¹—CH₂—CH(OH)—CH₂—(OA)ₙ-OR³ (I)
where R¹ is hydrocarbyl;
R² is H or hydrocarbyl;
X¹ is N; N⁺->O⁻; N⁺R⁴—where: R⁴— is C₁ to C₆ hydrocarbyl carrying an anionic substituent; or N⁺R⁵An⁻ where: R⁵ is a C₁ to C₂₀ hydrocarbyl; and An⁻ is a charge balancing anion;
OA is an oxyalkylene residue;
n is from 1 to 100; and
R³ is hydrocarbyl;
provided that at least one group R¹, R², R³ or R⁵ (when present) is or contains a C₆ to C₃₀ hydrocarbyl group.

2. A compound as claimed in claim 1 wherein R² is an alkyl, hydroxyalkyl or alkoxyalkyl group, R⁵ is an alkyl, hydroxyalkyl, alkoxyalkyl or aralkyl group, An⁻ is an alkali metal or ammonium ion, and R³ is a C₁₀ to C₃₋₀ alkyl, alkenyl, alkaryl, aryl or aralkyl group.

3. A compound as claimed in claim 1 wherein the oxyalkylene group(s) OA is (are) oxyethylene, oxypropylene or mixtures of oxyethylene and oxypropylene groups and n is from 1 to 50.

4. A compound as claimed in claim 1 wherein the oxyalkylene groups OA are all oxyethylene and n is from 8 to 30.

5. A compound as claimed in claim 1 wherein the oxyalkylene groups OA are mixtures of oxyethylene and oxypropylene groups; n is from 8 to 30 and the molar ratio of oxyethylene groups to oxypropylene groups is from 1:1 to 10:1.

6. An agrochemical composition of a compound as claimed in claim 1 and at least one agrochemically active compound.

7. An agrochemical composition of a compound of the formula (I′):
R¹R²X¹—CH₂—CH(OH)—CH₂—(OA)_{n′}-OR³ (I′)
where R¹, R², X¹, OA, and R³ are as defined for formula (I) in claim 1, and
n′ is from 0 to 100; and
at least one agrochemically active compound.

8. An agrochemical composition as claimed in claim 6 wherein the at least one agrochemically active compound is or includes one or more plant growth regulators, herbicides, and/or pesticides and/or bird repellants.

9. A composition as claimed in either claim 6 wherein the at least one agrochemically active compound is or includes at least one water soluble herbicide.

10. A composition as claimed in claim 9 wherein the water soluble herbicide is or includes at least one phosphonomethyl glycine; at least one phosphinyl amino acid; and/or at least one bipyridinium compound.

11. A method of treating vegetation by applying to plants and/or soil a composition as claimed in claim 6.

12. A method of killing or inhibiting vegetation by applying a formulation which includes one or more growth regulators and/or herbicides and at least one compound of the general formula (I) as defined in claim 1 and/or at least one compound of the general formula (I′) as an adjuvant.

13. A method of killing plant pests by applying a formulation as claimed in claim 7 which includes one or more pesticides and at least one compound of the general formula (I) and/or at least one compound of the general FORMULA (I′) as an adjuvant.
